(19) United States
(12) Patent Application Publication
(10) Pub. No.: US 2019/0131781 A1
(43) Pub. Date: May 2, 2019

(54) BEND RADIUS DEVICE FOR FLEXIBLE TUBE

(71) Applicant: BOMBARDIER INC., Dorval (CA)

(72) Inventors: Azer VELIEV, Pierrefonds (CA); Steve IALENTI, St-Leonard (CA); Gennaro NIGRO, Montreal (CA)

(21) Appl. No.: 16/091,136

(22) PCT Filed: Apr. 6, 2017
(86) PCT No.: PCT/IB2017/051987

§ 371 Date: Oct. 4, 2018

Related U.S. Application Data
(60) Provisional application No. 62/319,420, filed on Apr. 7, 2016.

(51) Int. Cl. H02G 3/04; F16L 43/02

(52) U.S. Cl. CPC H02G 3/0462; B64C 25/001; F16L 43/02; H02G 3/0406

(57) ABSTRACT

A floating bend radius device for limiting a radius of curvature of a flexible tube having a minimum bend radius, including first and second members. The first member has a curved contact surface having a radius of curvature at least equal to the minimum bend radius. The contact surface is concave in a plane transverse to the flexible tube's axial direction for contacting a portion of the flexible tube. The second member is engageable to the first member and complementary to the contact surface. The engaged members define a tube receiving space between the second member and the contact surface of the first member. The tube receiving space has a cross-sectional dimension configured to provide a compressive force on the flexible tube. At least one locking device may interconnect the members. A tube assembly including a bend radius device and a flexible tube is also discussed.

### CROSS-REFERENCE TO RELATED APPLICATION

This application claims priority from U.S. provisional application No. 62/319,420 filed Apr. 7, 2016, the entire contents of which are incorporated by reference herein.

### TECHNICAL FIELD

The application relates generally to the support of flexible tubes and, more particularly, to the support of flexible tubes subjected to bending during use.

### BACKGROUND OF THE ART

In an aircraft, a number of parts are movable relative to one another while being connected by flexible tubes such as electrical harnesses. For example, the main landing gear typically includes one or more electrical harnesses connected to the aircraft structure. Each electrical harness undergoes bending when the main landing gear is retracted and extended. A minimum bend radius for the harnesses must typically be respected to avoid damaging the harnesses and/or losing function during retraction and/or extension of the main landing gear.

Harnesses may be supported by fixed clamps attached to either the aircraft structure or the movable parts of the aircraft such as the main landing gear, to attempt to control bending of the harness to avoid bending with a radius of curvature less than its minimum bend radius. However, during movement of the harnesses, rubbing can occur against the fixed clamps, which can damage the harness through fretting.

Harnesses may also be circulated through controlled harness routing, however such routing does not provide specific support to the bending portion of the harness, which may still bend with a radius of curvature lower than its minimum bend radius.

### SUMMARY

In one aspect, there is provided a tube assembly comprising: a flexible tube having a minimum bend radius and extending between structural components; and a bend radius device connected to the flexible tube and being free from the structural components, the bend radius device including: a first member having a contact surface in contact with an inner bend surface of a portion of the flexible tube, the contact surface curved along an axial direction of the portion of the flexible tube and having a radius of curvature equal to or greater than the minimum bend radius of the flexible tube, and a second member in contact with an outer bend surface of the portion of the flexible tube, the second member connected to the first member and retaining the portion of the flexible tube against the contact surface of the first member, the connected first and second members providing a compressive force toward each other and against the portion of the flexible tube, the first and second members being detachable from one another.

In another aspect, there is provided a floating bend radius device for limiting a radius of curvature of a flexible tube having a minimum bend radius, the bend radius device comprising: a first member having a contact surface extending along a curved direction, the curved direction configured to extend along an axial direction of a portion of the flexible tube at least upon bending of the portion of the flexible tube, the contact surface curved with a radius of curvature at least equal to the minimum bend radius, the contact surface being concave in a plane transverse to the curved direction for contacting an inner bend surface of the portion of the flexible tube; a second member engageable to the first member, the second member complementary to the contact surface, the first and second members upon engagement defining a tube receiving space between the second member and the contact surface of the first member, the tube receiving space having a cross-sectional dimension configured to provide a compressive force on the flexible tube; and at least one locking device interconnecting the first and second members.

The tube assembly and/or the bend radius device may include any one or any combination of the following:
the second member is connected to the first member by at least one positive locking device;
the first and second members are completely detachable from one another;
the contact surface is curved following an arc of circle;
the second member is a clip cooperating with the contact surface to completely surround the portion of the flexible tube and/or to define the tube receiving space therebetween;
the clip is engageable to the first member in a selected one of at least two alternate locations spaced along the contact surface of the first member;
the contact surface is a first contact surface, the second member having a second contact surface complementary to the first contact surface, the portion of the flexible tube also extending in contact with at least part of the second contact surface;
the second member has a second contact surface concave along the direction transverse to the curved direction and complementary to the first contact surface to define the tube receiving space therebetween upon engagement of the first and second members;
the first member includes a first flange extending radially inwardly from the first contact surface, the second member includes a second flange extending radially inwardly from the second contact surface, and the second member is connected to the first member by at least one locking device interconnecting the first and second flanges;
the first and second contact surfaces extend between opposed first and second ends spaced along the axial direction of the flexible tube, the first and second contact surfaces being located a first radial distance from one another at the first and second ends and a second radial distance from one another intermediate the first and second ends, the flexible tube contacting the first and second contact surfaces intermediate the first and second ends, the first radial distance being greater than the second radial distance;
the first member includes at least two interconnected pieces each defining a respective part of the contact surface;
the structural components between which the flexible tube extends are movable in relation to each other.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an aircraft;

FIGS. 2a and 2b are schematic side views of interconnected fixed and movable structures which may form part of an aircraft such as shown in FIG. 1, including a tube assembly in accordance with a particular embodiment, and showing two different positions of the movable structure;

FIG. 3 is a schematic tridimensional view of a bend radius device of the tube assembly of FIGS. 2a-2b, in accordance with a particular embodiment;

FIG. 4 is an opposite schematic tridimensional view of the bend radius device of FIG. 3;

FIG. 5 is a schematic side view of a bend radius device of the tube assembly of FIGS. 2a-2b, in accordance with another particular embodiment;

FIG. 6 is a schematic front view of the bend radius device of FIG. 5;

FIG. 7 is a schematic side view of the bend radius device of FIG. 5, used with a single piece of an inner member thereof; and

FIG. 8 is a schematic front view of the bend radius device of FIG. 7.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION

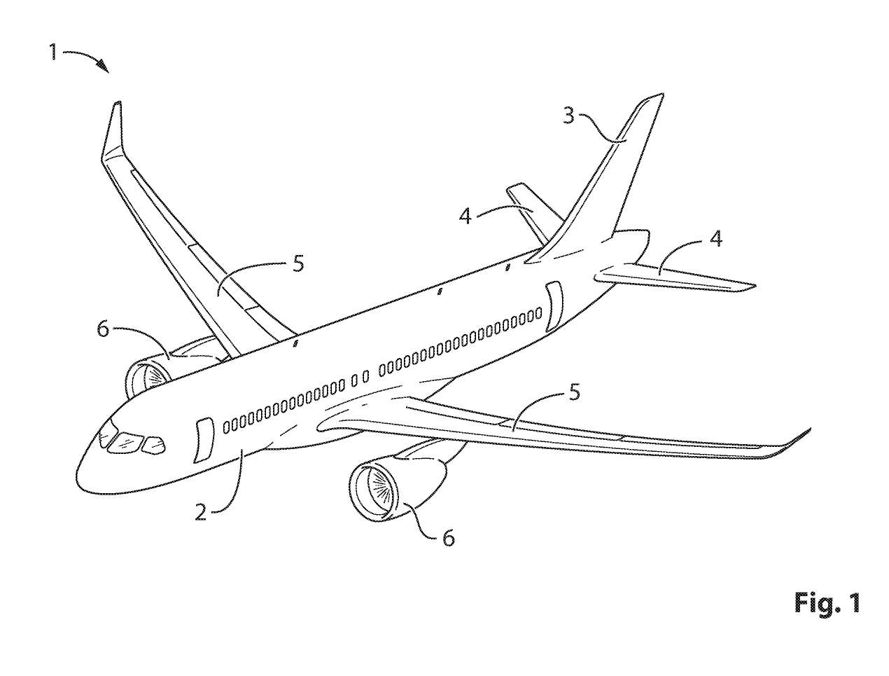

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

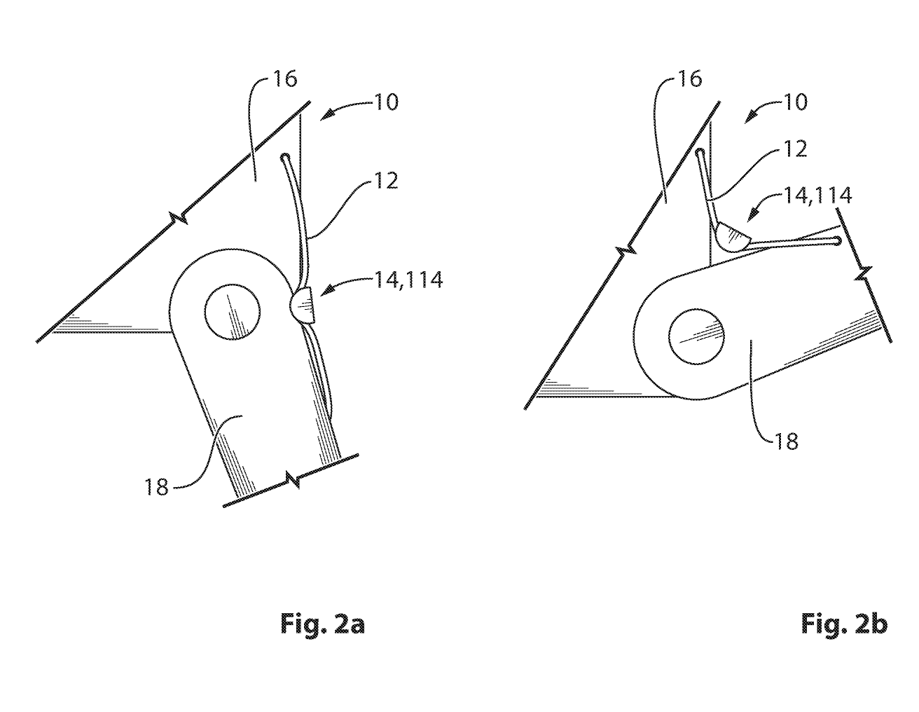

Referring to FIGS. 2a-2b, a tube assembly 10 is generally shown, including a flexible tube 12 and a bend radius device 14, 114 attached thereto. The flexible tube 12 extends between a fixed structure 16 of the aircraft 1 and a movable structure 18 of the aircraft 1, the movable structure 18 being movable (e.g. pivotable) with respect to the fixed structure 16, as illustrated by the different positions of FIGS. 2a and 2b. As will be further detailed below, the bend radius device 14, 114 is attached to the flexible tube 12 in a floating manner, i.e. it is connected only to the flexible tube 12, but is free to move with respect to the fixed and movable structures 16, 18. The flexible tube 12 has a minimum bend radius defining the tolerance of the flexible tube 12 to bending, where the flexible tube 12 is susceptible to damage and/or loss of function if bent with a local radius of curvature smaller than its minimum bend radius. The value of the minimum bend radius for a particular flexible tube 12 can be readily determined by the person of ordinary skill. For example, the minimum bend radius can be calculated based on the size and materials properties of the flexible tube 12; alternately, the minimum bend radius can typically be found in charts or data sheets provided by the supplier of the flexible tube 12. The bend radius device 14, 114 limits or controls the radius of curvature of the bend of the flexible tube 12 upon movement of the movable structure 18, such as to avoid bending of the flexible tube 12 to a radius of curvature smaller than its minimum bend radius.

In a particular embodiment, the fixed structure 16 is a part of the structure of the fuselage 2, and the movable structure 18 forms part of the main landing gear assembly of the aircraft 1, and is thus movable upon deployment and retraction of the main landing gear; the flexible tube 12 is an electrical harness wired to systems of the main landing gear, which bends when the main landing gear is retracted. It is understood that the tube assembly 10 may alternately be located in any part of the aircraft 1 where flexible tubes are found, such as for example the fuselage 2, the tail assembly or the wings 5, and that the flexible tube 12 may be any type of flexible tubing found in the aircraft 1, including, but not limited to, conduits (e.g. surrounding harnesses), electrical harnesses, hydraulic hoses, and pneumatic hoses.

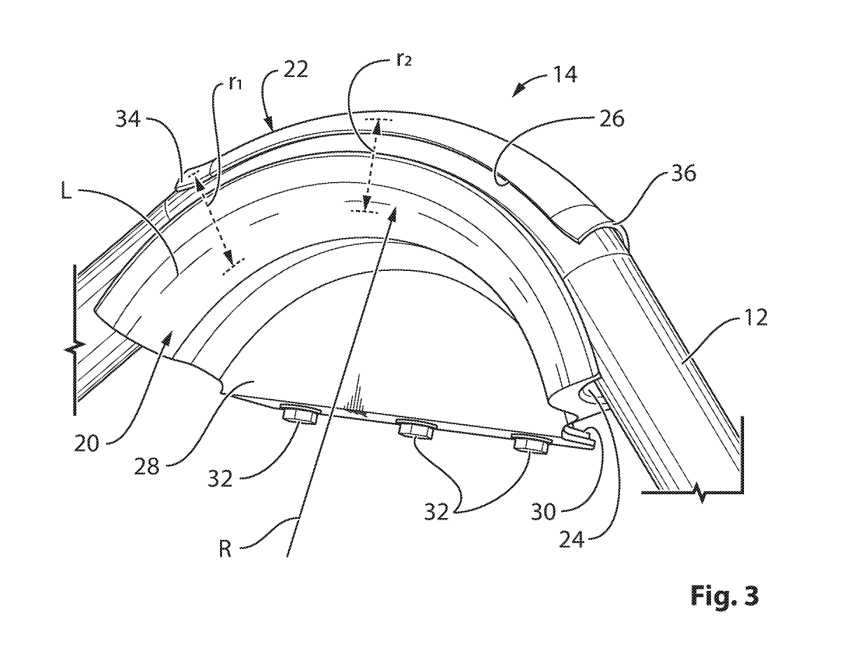

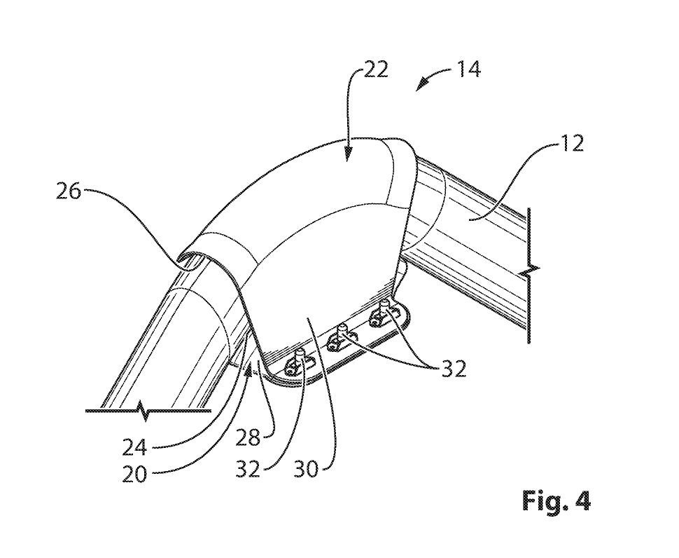

Referring to FIGS. 3-4, the bend radius device 14 according to a particular embodiment is shown, generally including two members 20, 22 connected to one another. The members 20, 22 are provided as separate pieces which can be detached from one another. In the embodiment shown, the members 20, 22 can be completely detached from one another. Alternately, the members 20, 22 may be partially detachable from one another; for example, the members 20, 22 may be connected such as to be movable with respect to each other so that the device 14 may be opened to receive the flexible tube 12, e.g. through a hinged connection. Other configurations are also possible.

The first or inner member 20 has a contact surface 24 which is elongated and extends along a curved direction L (FIG. 3) which is configured to extend in use along the axial direction of the portion of flexible tube 12 retained by the bend radius device 14, at least upon bending of this portion of flexible tube 12. The contact surface 24 is configured to contact the inner bend surface of the flexible tube 12 and limit its radius of curvature at the bend; the curved direction L of the contact surface has a radius of curvature R (FIG. 3) equal to or greater than (i.e. at least equal to) the minimum bend radius of the flexible tube 12. The inner member 20 is disposed radially inwardly of the second member 22 with respect to the center of the radius of curvature R of the curved direction L. The contact surface 24 is a radially outward surface of the inner member 20, and a portion of the flexible tube 12 is received against the contact surface 24, radially outwardly of the inner member 20. The contact surface 24 is concave in a plane transverse to the curved direction L, defining a cross-sectional shape complementary to that of the portion of the flexible tube 12 in contact therewith.

In the embodiment shown, the contact surface 24 is curved along the direction L following an arc of circle, i.e. with a constant radius of curvature R. It is understood that other curved configurations may be used for the contact surface 24, including a variable radius of curvature such as for example the contact surface 24 extending following an elliptical path, or any other shape allowing to maintain a curvature of the flexible tube 12 to a radius of curvature equal or greater to its minimum bend radius.

The second or outer member 22 is connected to the inner member 20 and retains the portion of the flexible tube 12 against the contact surface 24 of the inner member 20. The outer member 22 also includes a contact surface 26 complementary to the contact surface 24 of the inner member 20, located radially outwardly of the inner member 20 and of the portion of the flexible tube 12, and contacting the portion of the flexible tube 12. The contact surface 26 of the outer member 22 is also concave in the plane transverse to the curved direction L to define a cross-sectional shape complementary to that of the portion of the flexible tube 12 in contact therewith.

A tube receiving space is thus defined between the contact surfaces 24, 26 of the members 20, 22, having a cross-sectional dimension configured to provide a compressive force on the flexible tube 12. The portion of the flexible tube 12 extends in contact with the complementary contact surfaces 24, 26, sandwiched between the two members 20, 22. The connected members 20, 22 provide the compressive force toward each other and against the portion of flexible tube 12 received therebetween, to prevent relative movement along the curved direction L of the retained portion of flexible tube 12 (i.e. along the axial direction of the retained portion of the flexible tube 12) with respect to the members 20, 22. The compressive force is selected to be sufficient to prevent the relative movement while avoiding damage to or crushing of the flexible tube 12. In this manner and in a particular embodiment, fretting between the flexible tube 12 and the members 20, 22 is substantially avoided.

The two members 20, 22 are mechanically attached together to clamp the flexible tube 12 therebetween. In the embodiment shown, each member 20, 22 includes a L-shaped flange 28, 30 extending radially inwardly from its contact surface 24, 26, and the members 20, 22 are interconnected by fasteners 32 interconnecting the folded ends of the flanges 28, 30. Although three fasteners 32 are shown, it is understood that more or less fasteners 32 may be provided, depending on the particular retention requirements, for example based on the configuration of the flexible tube 12, bend radius device 14 and stress during use.

In the embodiment shown, each fastener 32 is configured as or includes a positive locking device. A positive locking device is locked such that the fastener cannot be disengaged by vibrations during use; the lock feature does not rely on the clamping force to be maintained. Accordingly, even if the vibrations slightly unthread the fastener, further unthreading of the fastener is limited such that the vibrations cannot completely disengage the fastener. Examples of positive locking devices include, but are not limited to, split beam nut with a split pin, castellated nut with a split pin, hex nut or cap screw with a tab washer, hex nut or cap screw with a lock plate, fastener with safety wiring, self-locking nuts, fastener with cotter pin.

Alternately, in applications where positive locking devices are not required, each fastener 32 may define a locking device other than a positive locking device. For example, each fastener 32 may be configured as a friction locking device, i.e. a fastener using friction as a locking feature. Examples of friction locking devices include, but are not limited to, fasteners including nylon inserts, and fasteners including out-of-round nuts.

As can be best seen in FIG. 3, the radial distance between the two contact surfaces 24, 26 is not constant along the curved direction L. The contact surface 26 of the outer member 22 extends between two opposed ends 34, 36; a first radial distance r₁ is defined between the contact surfaces 24, 26 at the opposed ends 34, 36, and a second radial distance r₂ is defined between the contact surfaces 24, 26 in an intermediate section intermediate the first and second ends 34, 36. The first radial distance r₁ is greater than the second radial distance r₂. Moreover, the contact surface 26 of the outer member 22 is shorter along the curved direction L than the contact surface 24 of the inner member 20; the contact surface 24 of the inner member 20 extends beyond the first and second ends 34, 36 of the contact surface 26 of the outer member 22. Accordingly, although the flexible tube 12 extends in contact with the contact surfaces 24, 26 intermediate the first and second ends 34, 36 of the outer contact surface 26, the flexible tube 12 can undergo limited radial movement within the first and second ends 34, 36, and over the portions of the inner contact surface 24 extending beyond the first and second ends 34, 36. The tube receiving space is thus flared at the opposed ends 34, 36, allowing for radial movement of the flexible tube 12 at this location, for example upon bending and unbending of the flexible tube 12. In a particular embodiment, such a configuration reduces or eliminates fretting and wear of the flexible tube 12 against the bend radius device 14, and/or allows a larger range of bend or wrap angle of the flexible tube 12 while also protecting the flexible tube 12 from pinching in the extreme conditions of its motion.

In the embodiment shown, the first radial distance r₁ is constant within the intermediate section defined between the opposed ends 34, 36; the second radial distance r₂ then progressively increases from the value of r₁ within the ends 34, 36, as the distance from the intermediate section along the curved direction L increases.

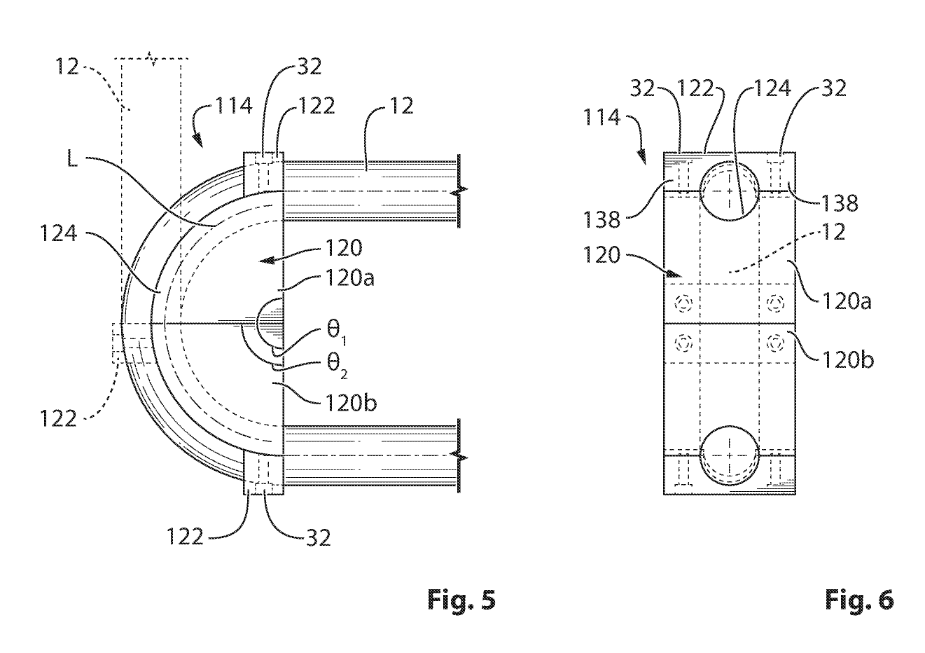

Referring to FIGS. 5-8, the bend radius device 114 according to another embodiment is shown. The bend radius device includes an inner member 120 and one or more (two being shown) outer members 122.

The inner member 120 has a contact surface 124 extending along the curved direction L (FIG. 5), configured to contact the flexible tube 12 and limit the radius of curvature of the flexible tube 12 upon bending, with the curved contact surface 124 having a radius of curvature equal to or greater than the minimum bend radius of the flexible tube 12. The contact surface 124 is also concave in a plane transverse to the curved direction L (FIG. 6), defining a cross-sectional shape complementary to that of the portion of the flexible tube 12 in contact therewith.

In the embodiment shown and referring particularly to FIG. 5, the contact surface 124 extends along the direction L following an arc of circle, and the contact surface 124 extends around an angle θ₁. In the embodiment shown, θ₁ has a value of 180 degrees, or approximately 180 degrees. It is understood that alternate values are possible, depending on the required bend or wrap angle for the flexible tube 12.

Each outer member 122 is provided in the form of a clip cooperating with the contact surface 124 to completely surround (i.e. surround a perimeter of) the portion of the flexible tube 12. In a particular embodiment, each clip 122 is engageable to the inner member 120 in a selected one of two or more locations spaced along the curved direction L. The position of the clip(s) 122 at desired tangent points is thus selected to provide for a predetermined wrap angle of the flexible tube 12. In the embodiment shown in solid lines, two clips 122 are spaced to maintain the flexible tube 12 against the contact surface 124 around the entire angle θ₁; in the embodiment shown in dotted lines, one of the two clips 122′ is attached at a different position such that the two clips 122, 122′ are closer together and maintain the flexible tube 12 against the contact surface 124 around a wrap angle θ₂ which is smaller than the angle θ₁ In the embodiment shown, θ₂ has a value of 90 degrees, or approximately 90 degrees. It is understood that alternate values are possible, depending on the required wrap angle for the flexible tube 12.

Each clip 122 is U-shaped, and a tube receiving space is defined between each clip 122 and the contact surface 124, having a cross-sectional dimension configured to provide the compressive force on the flexible tube 12 as discussed above.

Each clip 122 is mechanically attached to the inner member 120 to clamp the flexible tube 12 against the contact surface 124. In the embodiment shown and referring to FIG. 6, each clip 122 has two ends 138 with the flexible tube 12 received between the two ends 138, and each end 138 is attached to the inner member 120 by a corresponding fastener 32. In a particular embodiment, each fastener 32 is configured as or includes a positive locking device such as detailed above.

Although two clips 122 are shown, it is understood that alternately a single clip may be provided, or more than two clips may be provided.

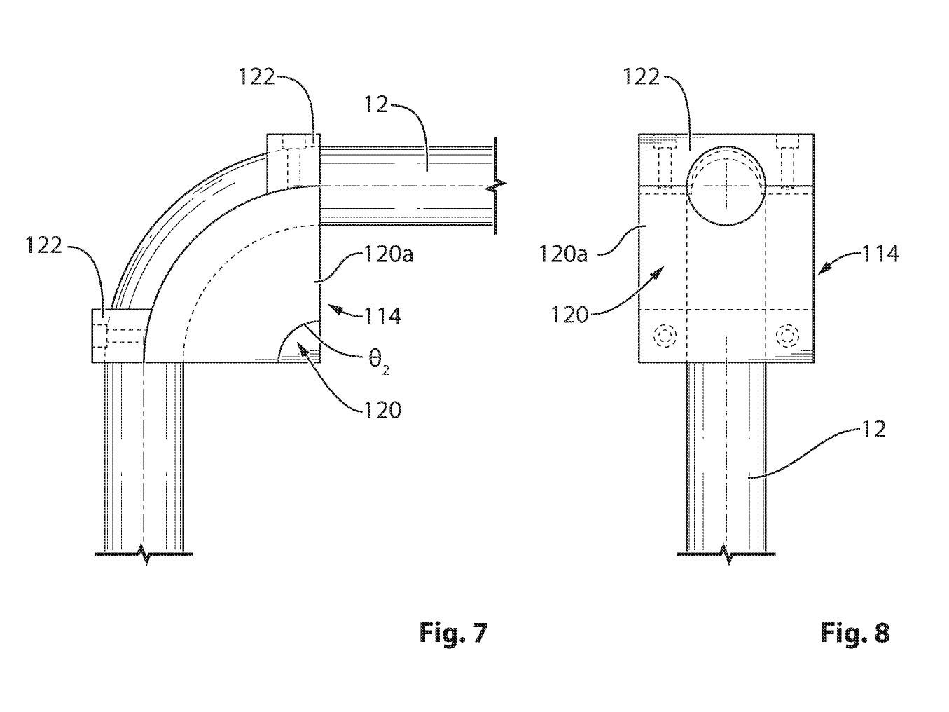

In the particular embodiment shown in FIGS. 5-6, the inner member 120 is modular, including two or more interconnected pieces 120a, 120b (two in the embodiment shown) each defining a respective part of the contact surface 124. The pieces 120a, 120b each extend around a respective wrap angle; although in the embodiment shown the two pieces 120a, 120b define the same wrap angle θ₂ (90 degrees), it is understood that the inner member 120 may be made of two or more pieces extending around different wrap angles from one another. The pieces 120a, 120b may be combined or used individually (as shown by piece 120a in FIGS. 7-8), and the positions of the clips 122 may be adjusted, to together provide for a wide variety of wrap angles suitable for different flexible tubes, allowing the same bend radius device 114 to be used with flexible tubes which bend at different angles from one another in use, with the wrap angle of each flexible tube being determined based on the extreme conditions of its motion.

As mentioned above, it is understood that the bend radius device 14, 114 can be used with any type of flexible tube 12, particularly, but not limited to, tubing or harnesses that undergo movement during use, such as electrical harnesses, pneumatic hoses, hydraulic hoses, etc.

It is understood that the bend radius device 14, 114 can maintain any appropriate portion of the flexible tube 12 against its contact surface(s). For example, a smaller portion of the flexible tube 12 may contact the contact surface(s) when the flexible tube 12 is in its extended position, as compared to its bent position, i.e. the bend radius device 14, 114 may be configured so that the flexible tube 12 is movable with respect to part of the contact surface(s) upon bending and extension of the flexible tube 12.

Although the bend radius device 14, 114 has been shown in a configuration suitable to support a single flexible tube 12, it is understood that a similar bend radius device 14, 114 may be provided to support two or more flexible tubes 12, for example defining side-by-side elongated contact surfaces 24, 124 on the inner member 20, 120 and complementary outer member(s) 22, 122 to engage the flexible tubes 12.

The bend radius devices 14, 114 discussed herein provide support to the flexible tube 12 without being attached to the structures between which the flexible tube 12 extends, i.e. in a floating manner. Accordingly, in a particular embodiment, the bend radius device 14, 114 may be added at any phase of the design without impact on the surrounding structure, since no structural interface is required. The bend radius device 14, 114 may be for example used with controlled routing, sized to remain within the routing envelope.

The bend radius device 14, 114 allows for constant support of the flexible tube 12; when placed on each part of the flexible tube 12 subjected to bending in use, it ensures that the flexible tube 12 is not bent to a radius of curvature smaller than its minimum bend radius.

The bend radius device 14, 114 can be made of any material suitable with the environment and sufficiently rigid to avoid deformations during use. Depending on the temperature of the region where the bend radius device 14, 114 is received, suitable plastics and/or metals can be selected.

In a particular embodiment, the bend radius device 14, 114 allows for support of the flexible tubes 12 with no or minimal risk of fretting, cracking or other type of wear for the flexible tubes 12.

In a particular embodiment, the bend radius device 14, 114 provides for a lightweight and low cost solution to the need to limit the radius of curvature of flexible tubes 12 upon bending, for example as compared to prior art systems such as clamps fixed to the structure of the aircraft.

Although the bend radius device 14, 114 has been described in relation to an aircraft 1, it is understood that it can be applied to any structure where flexible tubes need to be supported, including, but not limited to, any other type of vehicle having movable elements (e.g. doors) receiving flexible tubes.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A tube assembly comprising:
a flexible tube having a minimum bend radius and extending between structural components; and
a bend radius device connected to the flexible tube and being free from the structural components, the bend radius device including:
a first member having a contact surface in contact with an inner bend surface of a portion of the flexible tube, the contact surface curved along an axial direction of the portion of the flexible tube and having a radius of curvature equal to or greater than the minimum bend radius of the flexible tube, and
a second member in contact with an outer bend surface of the portion of the flexible tube, the second member connected to the first member and retaining the portion of the flexible tube against the contact surface of the first member, the connected first and second members providing a compressive force toward each other and against the portion of the flexible tube, the first and second members being detachable from one another,
wherein the contact surface is a first contact surface, the second member having a second contact surface complementary to the first contact surface, the portion of the flexible tube also extending in contact with the second contact surface, and wherein the first member includes a first flange extending radially inwardly from the first contact surface, the second member includes a second flange extending radially inwardly from the second contact surface, and the second member is connected to the first member by at least one locking device interconnecting the first and second flanges.

2. The tube assembly as defined in claim 1, wherein the second member is connected to the first member by at least one positive locking device.

3. The tube assembly as defined in claim 1, wherein the first and second members are completely detachable from one another.

4. The tube assembly as defined in claim 1, wherein the contact surface is curved following an arc of circle.

5. The tube assembly as defined in claim 1, wherein the second member is a clip cooperating with the contact surface to completely surround the portion of the flexible tube.

6. The tube assembly as defined in claim 5, wherein the clip is engageable to the first member in a selected one of at least two alternate locations spaced along the contact surface of the first member.

7.-8. (canceled)

9. The tube assembly as defined in claim 1, wherein the first and second contact surfaces extend between opposed first and second ends spaced along the axial direction of the flexible tube, the first and second contact surfaces being located a first radial distance from one another at the first and second ends and a second radial distance from one another intermediate the first and second ends, the flexible tube contacting the first and second contact surfaces intermediate the first and second ends, the first radial distance being greater than the second radial distance.

10. The tube assembly as defined in claim 1, wherein the first member includes at least two interconnected pieces each defining a respective part of the contact surface.

11. The tube assembly as defined in claim 1, wherein the structural components between which the flexible tube extends are movable in relation to each other.

12. A floating bend radius device for limiting a radius of curvature of a flexible tube having a minimum bend radius, the bend radius device comprising:
a first member having a contact surface extending along a curved direction, the curved direction configured to extend along an axial direction of a portion of the flexible tube at least upon bending of the portion of the flexible tube, the contact surface curved with a radius of curvature at least equal to the minimum bend radius, the contact surface being concave in a plane transverse to the curved direction for contacting an inner bend surface of the portion of the flexible tube;
a second member engageable to the first member, the second member complementary to the contact surface, the first and second members upon engagement defining a tube receiving space between the second member and the contact surface of the first member, the tube receiving space having a cross-sectional dimension configured to provide a compressive force on the flexible tube; and
at least one locking device interconnecting the first and second members,
wherein the contact surface is a first contact surface, the second member having a second contact surface concave in the plane transverse to the curved direction and complementary to the first contact surface to define the tube receiving space therebetween upon engagement of the first and second members; and
wherein the first member includes a first flange extending radially inwardly from the first contact surface, the second member includes a second flange extending radially inwardly from the second contact surface, and the at least one locking device interconnects the first and second flanges.

13. The device as defined in claim 12, wherein the at least one locking device includes at least one positive locking device.

14. The device as defined in claim 12, wherein the contact surface is curved following an arc of circle.

15. The device as defined in claim 12, wherein the second member is a clip cooperating with the contact surface to define the tube receiving space therebetween.

16. The device as defined in claim 15, wherein the clip is engageable to the first member in a selected one of at least two alternate locations spaced along the contact surface of the first member.

17.-18. (canceled)

19. The device as defined in claim 12, wherein the first and second contact surfaces extend between opposed first and second ends spaced along the curved direction, the first and second contact surfaces being located a first radial distance from one another at the first and second ends and a second radial distance from one another intermediate the first and second ends, the first radial distance being greater than the second radial distance.

20. The device as defined in claim 12, wherein the first member includes at least two interconnected pieces each defining a respective part of the contact surface.
